(19) United States
(12) Patent Application Publication
(10) Pub. No.: US 2018/0089594 A1
(43) Pub. Date: Mar. 29, 2018

(54) INTELLIGENCE GENERATION BASED ON ADAPTIVE LEARNING

(71) Applicant: iCharts, Inc., Sunnyvale, CA (US)

(72) Inventors: Seymour Duncker, Los Altos, CA (US); Andrey Yruski, San Francisco, CA (US)

(21) Appl. No.: 15/717,590

(22) Filed: Sep. 27, 2017

Related U.S. Application Data
(60) Provisional application No. 62/400,383, filed on Sep. 27, 2016.

(51) Int. Cl. G06N 99/00; G06N 7/00

(52) U.S. Cl. CPC G06N 99/005; G06N 7/005

(57) ABSTRACT

An analysis server receives data of multiple types. The analysis server uses multiple generated and pre-trained analysis models and semantic layer operations to analyze the data and search for and detect correlations, trends, and/or predictions using adaptive artificial intelligence or machine learning algorithms. The analysis server then transmits data to a viewer device identifying the detected correlations, trends, and/or predictions, thereby displaying notifications, charts, or graphs at the viewer device. The analysis server may then check to see if the detected correlations, trends, and/or predictions hold true based on new data, and can adjust, augment, or evolve the pre-trained analysis models based on this, or can assign or adjust confidence scores to each of the pre-trained analysis models based on this.

### CROSS-REFERENCE TO RELATED APPLICATIONS

The present application claims the priority benefit of U.S. provisional application No. 62/400,383 filed Sep. 27, 2016 and entitled “Intelligence Generation Based on Adaptive Learning,” the disclosure of which is hereby incorporated by reference.

### BACKGROUND

### 1. Field of the Invention

The present invention generally concerns data analytics and business intelligence. More specifically, the present invention concerns use of adaptive learning models to identify correlations, trends, and predictions based on multiple data types.

### 2. Description of the Related Art

With the continued proliferation of computing devices and the ubiquitous increase in Internet connectivity, dealing with vast amounts of complex data has become a norm in business and consumer markets. Analyzing such data can often be tedious, difficult, and time consuming.

Actionable information, such as predictions, trends, and correlations, is sought after by business leaders in forming long-term business strategies and short-term business decisions alike. Typically, business leaders pay large amounts to hire business intelligence analysts to sift through data and locate answers to specific questions.

Sometimes, unexpected correlations or trends may exist, such as tomato sales being affected by tide level or lunar phase. Because typical business intelligence analysts typically charge high rates, they are generally only hired to research a relatively narrow band of data in search of an answer to a specific question. As a result, typical business intelligence analysts are unlikely to find such unexpected correlations or trends and therefore might miss important actionable intelligence that is related to a question that no one would typically think to ask.

Therefore, there is a need in the art for improved business intelligence methods and systems.

### SUMMARY OF THE PRESENTLY CLAIMED INVENTION

A first claimed embodiment of the present invention concerns a system for providing intelligence. The system includes a memory storing a plurality of correlation analysis models, wherein each correlation analysis model is previously-trained and distinct from a remainder of the plurality of correlation analysis models. The system also includes a communication transceiver receiving data from a data source. The system also includes a processor coupled to the memory and to the communication transceiver. Execution of instructions stored in the memory by the processor performs a number of system operations. The system operations include identifying a correlation within the data using a first correlation analysis model of the plurality of correlation analysis models. The system operations also include adjusting a confidence metric associated with the correlation based on the other correlation analysis models within the plurality of correlation analysis models other than the first correlation analysis model. The system operations also include transmitting correlation data to a viewer device, thereby triggering a notification identifying the correlation to be output at the viewer device.

A second claimed embodiment of the present invention concerns a method of providing intelligence. The method includes storing a plurality of correlation analysis models in a memory, wherein each correlation analysis model is previously-trained and distinct from a remainder of the plurality of correlation analysis models. The method also includes receiving data from a data source and identifying a correlation within the data using a first correlation analysis model of the plurality of correlation analysis models. The method also includes adjusting a confidence metric associated with the correlation based on the other correlation analysis models within the plurality of correlation analysis models other than the first correlation analysis model. The method also includes transmitting correlation data to a viewer device, thereby triggering a notification identifying the correlation to be output at the viewer device.

A third claimed embodiment of the present invention concerns a stored program for providing analytic visualization data that is stored on a non-transitory computer-readable storage medium. The stored program may be executable by a processor to perform an exemplary method for providing intelligence. The executable program method includes storing a plurality of correlation analysis models in a memory, wherein each correlation analysis model is previously-trained and distinct from a remainder of the plurality of correlation analysis models. The executable method also includes receiving data from a data source and identifying a correlation within the data using a first correlation analysis model of the plurality of correlation analysis models. The executable method also includes adjusting a confidence metric associated with the correlation based on the other correlation analysis models within the plurality of correlation analysis models other than the first correlation analysis model. The executable method also includes transmitting correlation data to a viewer device, thereby triggering a notification identifying the correlation to be output at the viewer device.

### BRIEF DESCRIPTION OF THE FIGURES

FIG. 1 illustrates data transfers within an intelligence ecosystem.

FIG. 2 is a flow diagram illustrating exemplary intelligence generation operations of an analysis server.

FIG. 3 illustrates intelligence output at a viewer device.

FIG. 4 illustrates various analytic visualization formats.

FIG. 5 is a block diagram of an exemplary computing device that may be used to implement an embodiment of the present invention.

### DETAILED DESCRIPTION

An analysis server receives data of multiple types. The analysis server uses multiple generated and pre-trained analysis models and semantic layer operations to analyze the data and search for and detect correlations, trends, and/or predictions using adaptive artificial intelligence or machine learning algorithms. The analysis server then transmits data to a viewer device identifying the detected correlations, trends, and/or predictions, thereby displaying notifications, charts, or graphs at the viewer device. The analysis server may then check to see if the detected correlations, trends, and/or predictions hold true based on new data, and can adjust, augment, or evolve the pre-trained analysis models based on this, or can assign or adjust confidence scores to each of the pre-trained analysis models based on this.

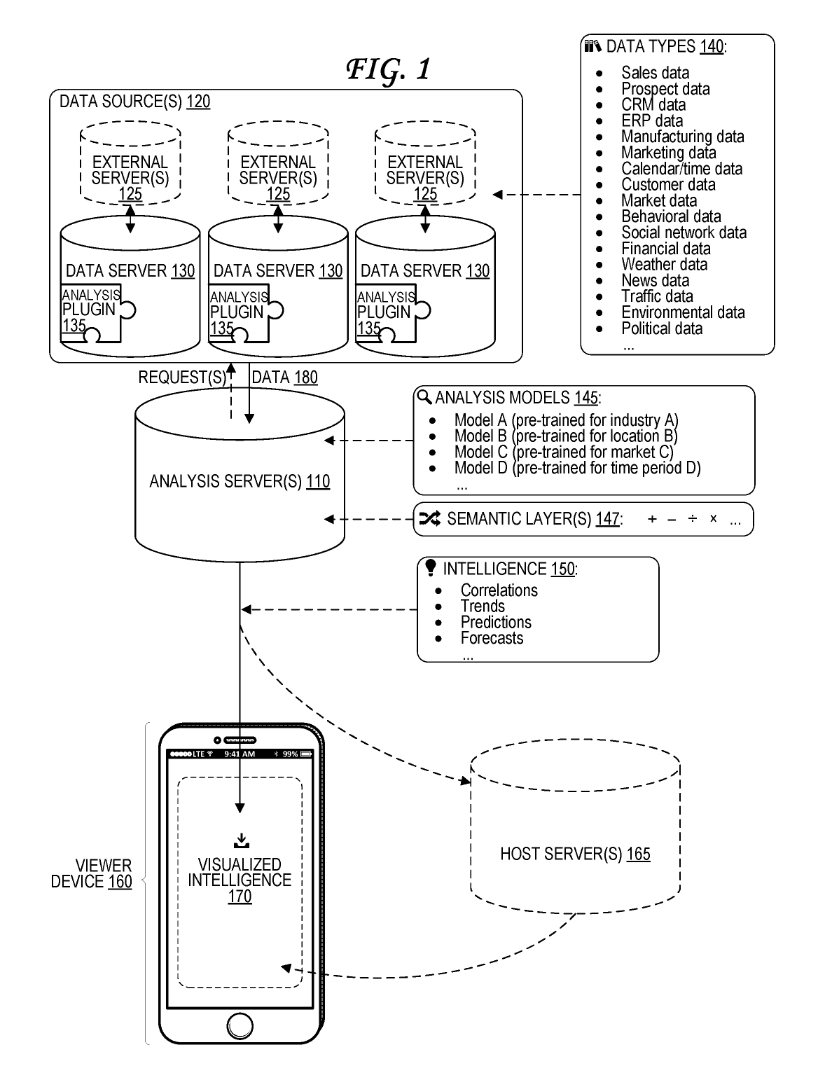

FIG. 1 illustrates data transfers within an intelligence ecosystem.

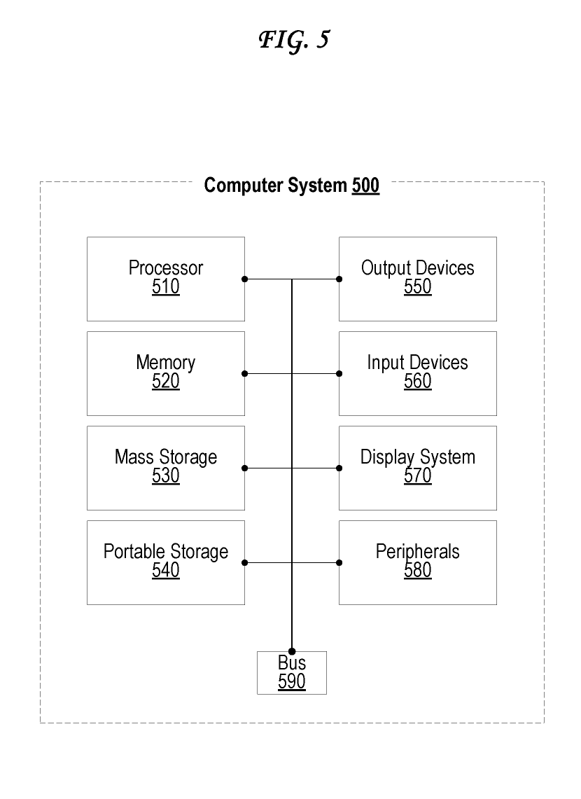

The intelligence ecosystem of FIG. 1 centers around an analysis server 110, which may be a computer system 500 or may include at least a subset of the components found in a computer system 500 as described in relation to FIG. 5.

The analysis server 110 is in communicative with one or more data source(s) 120, which may include one or more data server(s) 130 with an analysis plugin 135 installed onboard and may also include one or more external server(s) 125 without an analysis plugin 135 installed onboard. Each data source 120 (i.e., each data server 130 and each external server 125) may be a computer system 500 or may include at least a subset of the components found in a computer system 500 as described in relation to FIG. 5.

The data sources 120 may cumulatively store a full dataset (not pictured), which may include many data types 140. Each data source 120 may store at least some portion of the full dataset. The data source(s) 120 then transmit data 180 to the analysis server 110. The data 180 that is transmitted may include at least a subset of the full dataset. For example, the data sources 120 may transfer the full dataset to the analysis server 110 and subsequently transfer “delta” datasets identifying changes to the full dataset, including additions and deletions.

The different data types 140 stored within the data source(s) 120 may include sales data, prospect data, customer relationship management (CRM) data, enterprise resource planning (ERP), manufacturing data, marketing data, calendar data, time data, customer data, market data, customer/prospect behavioral data, financial data, weather data, news data, traffic data, environmental data, political data, or some combination thereof. Market data and financial data may include data about individual customers, and may in some cases identify an individual customer's past purchases, income, loans, credit, or expenses. Market data and financial data may also include global or regional data, such as market index/stock swings/trends worldwide or regionally, foreclosures worldwide or regionally, regional industry expertise areas, or global or regional purchase trends. Political data may include global, regional, or individual political leanings, and may also identify parties or individuals currently in power or predicted to be in power. Weather data may identify past, present, or forecasted weather. Environmental data may identify past, present, or forecasted data that may describe pollution, allergens, earthquake activity, volcanic activity, water level, tide level, lunar phase, eclipse dates, solar flare activity, or radiation information. Calendar data may identify days of the week as well as global or regional holidays, and may also identify school holiday/vacation days and individual birthdays or namedays.

The analysis plugin 135 may include software, hardware, or some combination thereof, and may aid or accelerate transfer of the data 180 from the data source(s) 120 to the analysis server 110, for example by communicating with the analysis server 110 so that only certain categories, classifications, or types of data are transferred over. This may further serve to increase security, since not all of the data stored at the data sources 120 is then transferred over the network as the data 180 that is ultimately received by the analysis server 110. This leaves the data source(s) 120 less vulnerable to data theft or loss via man-in-the-middle or similar network-based attacks.

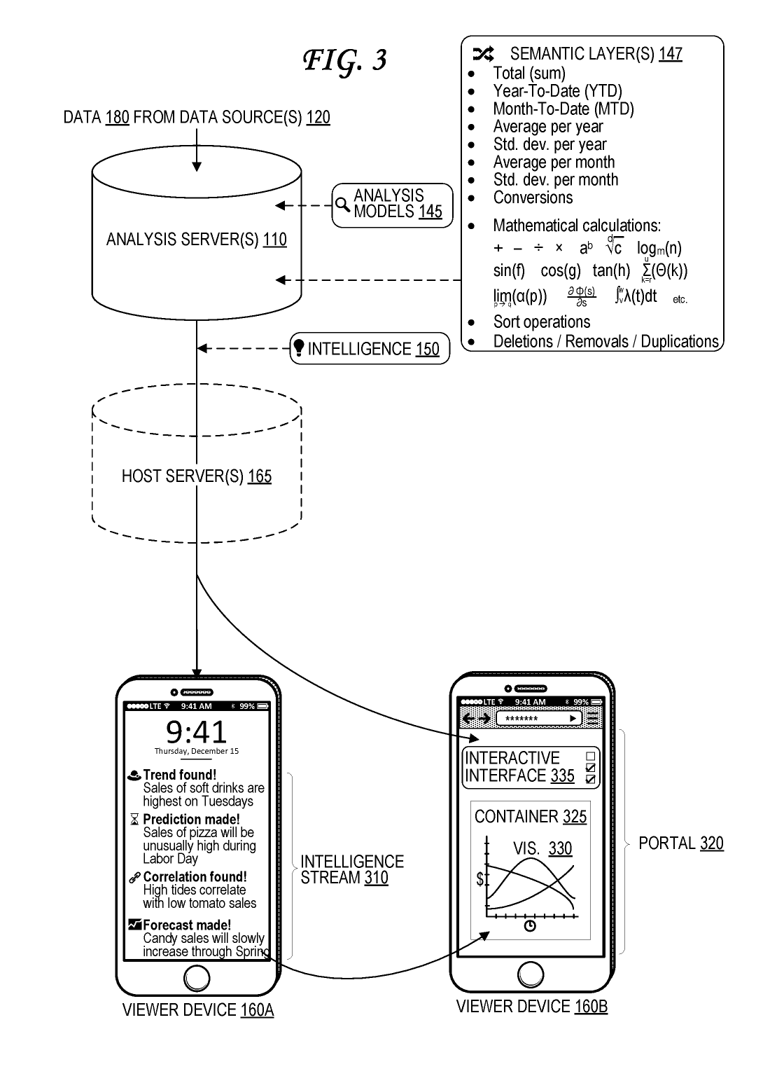

In some cases, the viewer device 160 may transmit an identifier to the analysis server 110, to the data source 120, to the host server 165, to another intermediate identity-verification server, or some combination thereof. The identifier may be one of any of the identifier types discussed with regard to FIG. 3, and may include two-factor authentication identity verification. The analysis server 110 and/or the analysis plugin 135 of the data sources 120 can then extract more or less data 180 from the data sources 120 based on the identifier. In this way, a high-ranking executive of a company might have access to intelligence 150 based on a greater amount of data 180 than a low-level employee or shareholder.

After receiving the data 180 from the data sources 120, the analysis server 110 identifies intelligence 150, namely correlations, trends, predictions, or forecasts, based on one or more analysis models 145. Any trends, predictions, and forecasts within the intelligence 150 may in some cases be based on identified correlations. The analysis models 145 can use different probability, artificial intelligence, and machine learning algorithms to generate the intelligence 150. For example, an analysis model 145 may use Bayesian inference, clustering algorithms, approximation algorithms, neural networks, weighted graph algorithms, regression analysis, exponential smoothing, autoregressive integrated moving averages, or some combination thereof to identify intelligence 150 based on the data 180 or some subset thereof.

The analysis models 145 can be adaptively learning models that are altered based on the continuing accuracy of the correlations, trends, predictions, or forecasts that they predict. For example, if a prediction or forecast does not come true, the analysis model 145 that generated that prediction or forecast may alter itself based on what actually happened, so that if similar data 180 is presented to it again in the future, the analysis model 145 will have an increased probability of predicting or forecasting what actually happened the last time and a decreased probability of predicting or forecasting what it previously predicted/forecasted incorrectly. Similarly, an analysis model 145 may check to see if a correlation or trend continues to hold after the new data 180 has been received and/or after a predetermined duration of time has elapsed. If the correlation/trend continues to hold after the new data 180 has been received and/or after the predetermined duration of time has elapsed, the analysis model 145 may alter itself to heighten its probability of presenting that correlation/trend in the future if given similar data 180. If the correlation/trend fails to hold after the predetermined duration of time has elapsed, the analysis model 145 may alter itself to decrease its probability of presenting that correlation/trend in the future if given similar data 180.

The different analysis models 145 may each use different algorithms, or may share algorithms, or some combination thereof. The different analysis models 145 may be generated based on the data 180, pre-trained on data other than the data 180, or some combination thereof. Pre-trained or partially pre-trained analysis models 145 provide the benefit of being ready to generate relatively accurate correlations, trends, predictions, and forecasts before the data 180 is fed through them. Each analysis model 145, if pre-trained or partially pre-trained, may be pre-trained using different pre-training data. Each analysis model 145 may then augment or evolve its training based on the data 180 or some subset of the data 180.

For example, FIG. 1 identifies a Model A that is pre-trained or partially pre-trained for a particular Industry A. For instance, if the data 180 sales data for various food and beverage products, the analysis server 110 might select an analysis model 145 that is pre-trained or partially pre-trained on pre-training data that was focused on the restaurant industry, a model 145 pre-trained on pre-training data focused on the grocery store industry, a model 145 pre-trained on pre-training data focused on the food manufacturing/processing/distribution industries, and a model 145 pre-trained on pre-training data focused on the soft drink industry. An analysis model 145 that is focused on a particular industry, like Model A of FIG. 1, may then augment or evolve its training based on the data 180 or some subset of the data 180. For example, an analysis model 145 focused on a particular identified industry may augment or evolve its training based on a subset of the data 180, the subset focused on the identified industry that the model is focused on and/or ancillary industries that serve or are otherwise related to the identified industry.

FIG. 1 also identifies a Model B that is pre-trained or partially pre-trained for a particular location/region B. For example, the analysis server 110 might select an analysis model 145 pre-trained on pre-training data that was focused on a particular, city, county, state, country, continent, climate region, or some combination thereof. An analysis model 145 that is focused on a particular location or region, like Model B of FIG. 1, may then augment or evolve its training based on the data 180 or some subset of the data 180. For example, an analysis model 145 focused on a particular identified location or region may augment or evolve its training based on a subset of the data 180, the subset focused on the identified location or region that the model is focused on and/or neighboring locations or regions and/or locations or regions with similar economic, demographic, population density, or climate characteristics.

The model may assign different weights to different subsets of the data 180 and may augment or evolve its training more heavily based on subsets with higher weights. In this case, high weight values may be assigned to subsets that closely match the identified location or region, middle weight values may be assigned to subsets that match locations or regions that neighbor or are similar to the identified location or region, and low/zero weight values may be assigned to all other subsets of the data 180.

FIG. 1 also identifies a Model C that is pre-trained or partially pre-trained for a particular Market C, the market being economic, demographic, region-based, or some combination thereof. For example, the analysis server 110 might select an analysis model 145 pre-trained on pre-training data that was focused on urban markets, suburban markets, rural markets, wealthy markets, middle-class markets, poorer markets, markets consisting of a single gender, markets focused on one or more particular ethnicities, or some combination thereof. An analysis model 145 that is focused on a market, like Model C of FIG. 1, may then augment or evolve its training based on the data 180 or some subset of the data 180. For example, an analysis model 145 focused on a particular identified market may augment or evolve its training based on a subset of the data 180, the subset focused on the identified market that the model is focused on and/or other markets with similar characteristics.

The model may assign different weights to different subsets of the data 180 and may augment or evolve its training more heavily based on subsets with higher weights. In this case, high weight values may be assigned to subsets that closely match the identified market, middle weight values may be assigned to subsets that are similar to the identified market, and low/zero weight values may be assigned to all other subsets of the data 180. For example, if the market is urban males, the analysis model 145 might augment or evolve its training strongly based on a subset of the data 180 that is also about urban males, and might augment or evolve its training slightly based on a subset of data 180 that is about urban females or suburban males.

FIG. 1 also identifies a Model D that is pre-trained or partially pre-trained for a particular time period D. For example, the analysis server 110 might select an analysis model 145 that is pre-trained using data gathered during workdays, holidays, weekdays, weekends, school vacation days, or some combination thereof. Alternately, the analysis server 110 might select an analysis model 145 that is pre-trained using data gathered during a particular time span, such as a particular day, week, month, season, year, decade, century, millennium, fiscal year quarter, or some combination thereof. An analysis model 145 that is focused on a time period, like Model D of FIG. 1, may then augment or evolve its training based on the data 180 or some subset of the data 180. For example, an analysis model 145 focused on a particular identified time period may augment or evolve its training based on a subset of the data 180, the subset focused on the identified time period that the model is focused on and/or other time periods with similar characteristics. For instance, if the identified time period is a particular holiday, the similar time periods may include other holidays or weekends. If the identified time period is weekends in general, the similar time periods may include holidays or Fridays. If the identified time period is Summer, the similar time periods may include neighboring seasons Spring and Autumn. If the identified time period is the 1990s, the similar time periods may include neighboring decades the 1980s and the 2000s.

The model may assign different weights to different subsets of the data 180 and may augment or evolve its training more heavily based on subsets with higher weights. In this case, high weight values may be assigned to subsets that closely match the identified time period, middle weight values may be assigned to subsets that are similar to the identified time period as discussed above, and low/zero weight values may be assigned to all other subsets of the data 180. For example, if the identified time period is fiscal quarter 2, the analysis model 145 might augment or evolve its training strongly based on a subset of the data 180 that is also about fiscal quarter 2, and might augment or evolve its training slightly based on a subset of data 180 that is about neighboring fiscal quarter 1 and/or fiscal quarter 3.

It should further be understood that some analysis models 145 may not be pre-trained at all, and may be generated solely based on the processed described above regarding use of the data 180 or subsets thereof to augment or evolve training of analysis models 145.

In addition to the analysis models 145, the analysis server 110 may run the data 180, or a subset thereof, through one or more semantic layer operations 147. These can include a variety of filtering operations as well as a variety of mathematical operations, and are discussed in more detail in relation to FIG. 3.

Once the analysis server 110 has generated intelligence 150 (i.e., one or more correlations, trends, probabilities, or forecasts) through one or more of its analysis models 145 and/or one or more of its semantic layer operations 147, the analysis server 110 transmits the intelligence 150 to a viewer device 160, either directly or indirectly through one or more host server(s) 165. Once the intelligence 150 reaches the viewer device 160, it is displayed as visualized intelligence 170. Visualized intelligence 170 may include notifications, such as text-based notifications, image-based notification, video-based notifications, audio-based notifications, or some combination thereof. These notifications may take many forms, such as email, short message service (SMS) text message, Multimedia Messaging Service (MMS) message, software application notification, or a message in a chat service/platform. Chat services/platforms include, for example, Apple iMessage, Google Hangouts, WhatsApp, Slack, HipChat, Facebook Messenger, Blackberry Messenger, Yahoo Messenger, Symphony Communication, Signal, Cryptocat, Instant Bloomberg, AOL Instant Messenger, various Extensible Messaging and Presence Protocol (XMPP) based messaging services, various Open Whisper based messaging services, or some combination thereof. Visualized intelligence 170 may also include analytic visualizations, such as graphs, charts, or tables, which in some cases may be interactive.

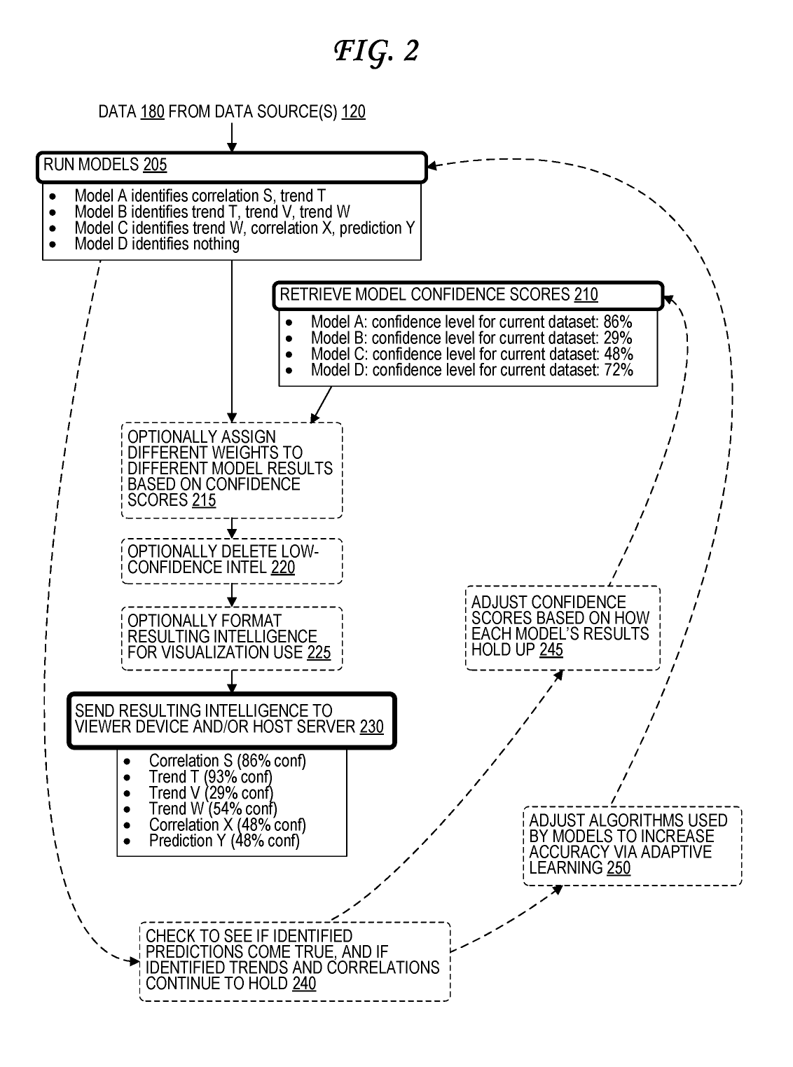

FIG. 2 is a flow diagram illustrating exemplary intelligence generation operations of an analysis server. The intelligence generation operations illustrated in FIG. 2 are performed by the analysis server 110.

The intelligence generation operations illustrated in FIG. 2 begin at receipt of data 180 from the data source(s) 120 at the analysis server 110. At step 205, the analysis server 110 runs the data 180 through its analysis models 145. At step 210, the analysis server 110 retrieves model confidence scores for each model. The exemplary analysis models 145 of FIG. 2 include a Model A with an 86% confidence score, a Model B with a 29% confidence score, a Model C with a 38% confidence score, and a Model D with a 72% confidence score.

At step 215, the analysis server 110 assigns different weights to different model results based on the confidence scores retrieved at step 210. For example, if only one low-confidence model detects a correlation, it may be weighted poorly. On the other hand, if three high-confidence analysis models 145 all detect a correlation, it may instead be weighted very well. These weights may then be translated back into confidence scores within the visualized intelligence 170 for greater readability.

At step 220, the analysis server 110 may delete low-confidence findings. That is, a lower threshold value may be pre-determined, and if a confidence or weight associated with a certain correlation, trend, prediction, or forecast is below that threshold, it may be deleted. For example, intelligence produced by a single low-confidence model might be deleted. Intelligence produced by one model that is directly contradicted by intelligence produced by another model might also be deleted. In some cases, intelligence that is simply not corroborated by enough models may be deleted.

At step 225, the intelligence 150 gathered from all of the analysis models 145 may be formatted in a particular way so that it can be presented as visualized intelligence 170 at the viewer device 160. This may include natural language processing to format a notification into a complete, grammatically-correct, natural-sounding sentence. This may also include data conversions. This may also include generating a graph, chart, or table, or generating precursor data that might be used by the host server(s) 165 or viewer device 160 to then generate a graph, chart, or table.

At step 230, the analysis server sends the resulting intelligence 150 to the viewer device 160, either directly or through the host server(s) 165.

The exemplary intelligence illustrated in FIG. 2 corresponding to step 230 includes a Correlation S with an 86% confidence rating. This is based on Model A identifying Correlation S in step 205, and the 86% confidence rating for Model A identified in step 210. The step 230 intelligence illustrated in FIG. 2 also includes a Trend T with a 93% confidence rating. This is based on Model A and Model B both identifying Trend T, and on the 86% confidence rating of Model A combined with the 29% confidence rating of Model B. The step 230 intelligence illustrated in FIG. 2 also includes a Trend V with a 29% confidence rating. This is based on Model B identifying Trend V, and on the 29% confidence rating of Model B. The step 230 intelligence illustrated in FIG. 2 also includes a Trend W with a 54% confidence rating. This is based on Model B and Model C both identifying Trend W, and on the 29% confidence rating of Model B combined with the 48% confidence rating of Model C. The step 230 intelligence illustrated in FIG. 2 also includes a Correlation X and a Prediction Y, both with a 48% confidence rating. This is based on Model C identifying Correlation X and a Prediction Y, and on the 48% confidence rating of Model C. Model D does not find anything, and thus does not affect the exemplary intelligence presented in step 230. In an alternate embodiment, however, confidence in a piece of intelligence may be lessened if it is not corroborated by another model, and thus Model D might bring the confidence scores of all of the intelligence down by a bit.

At step 240, the analysis server 110 checks to see if identified predictions and forecasts come true, and if identified trends and correlations continue to hold after/during a predetermined duration of time.

At steps 245, the confidence scores for the different models may be adjusted based on how their respective intelligence holds up. If the intelligence from a particular model 145 holds true after the test of step 240, the confidence score of that model 145 may be increased. If the intelligence from a particular model 145 fails after the test of step 240, the confidence score of that model 145 may be decreased.

At steps 250, the algorithms used by the models may be adjusted based on how their respective intelligence holds up. If the intelligence from a particular model 145 holds true after the test of step 240, the algorithm(s) used by that model 145 may be conserved, or may be adjusted to be more likely to give the same or similar results given similar data 180. If the intelligence from a particular model 145 fails after the test of step 240, the algorithm(s) used by that model 145 may be adjusted to be less likely to give the same or similar results given similar data 180.

FIG. 3 illustrates intelligence output at a viewer device.

Two viewer devices 160 are illustrated in FIG. 3, along with the analysis server 11 and the optional host server(s) 165. The two viewer devices 160 are identified respectively as viewer device 160A and viewer device 160B and each include a different type of visualized intelligence 170.

The two viewer device 160 of FIG. 3, like the viewer device 160 of FIG. 1, receive intelligence 150 directly from the analysis server 110, indirectly from the from the analysis server 110 through one or more host server(s) 165, or some combination thereof. The intelligence 150 is based on the data 180 or some subset thereof. The intelligence 150 may be further based on stored at the analysis server 110, the analysis models 145 being pre-trained, partially pre-trained, or generated entirely based on the data 180 (or some subset thereof) as discussed in relation to FIG. 1. The intelligence 150 may also be based on one or more semantic layer operations 147.

For example, the semantic layer operations 147 may include sums, differences, products, ratios, percentages, unit conversions, scale changes, and more complex mathematical operations. Such a mathematical operations may include addition operations, subtraction operations, multiplication operations, division operations, exponent operations, root operations, mean operations, median operations, mode operations, standard deviation operations, logarithmic operations, trigonometric operations, statistical operations, derivative operations, integral operations, limit operations, matrix operations, vector operations, Fourier transform operations, unit conversion operations, or some combination thereof. Semantic layer operations 147 may also include sorting operations. In some cases, semantic layer operations 147 may also include non-mathematical operations, such as duplication or removal of one or more data entries from within the data 180.

The semantic layer operations 147 may include global semantic layer operations that are available to all users and/or all viewer devices 160. The semantic layer operations 147 may also include group-based semantic layer operations that are available only to a certain subset of users and/or viewer devices 160, optionally based on identifier data that is sent from the viewer devices 160 back to the analysis server 110 or an intermediate server connected to the analysis server 110, the intermediate server confirming identity based on the identifier. Such an identifier may include a browser cookie, a symmetric encryption key, an asymmetric public encryption key, an asymmetric private encryption key, a certificate signed by a certificate authority, a self-signed certificate, a password, a passcode, an identification number, a physical address, an email address, a phone number, a messenger platform username, biometric information, or some combination thereof. The identifier may in some cases be used to implement a two-factor authentication process in which the user is texted, messaged, emailed, or called with a confirmation code that can then be sent to the analysis server 110 to aid in authenticating the user.

When an identifier is sent by the viewer device 160, certain semantic layer operations 147 may be unlocked, for example, such as those for which a license needs to be purchased and tied to a user account associated with the viewer device 160. Some semantic layer operations may be available only to a specific group, such as accountants in an organization, because they might not be useful to anyone else. Some semantic layer operations might only be available to certain authorized users, which may be checked based on the identifier. Some semantic layer operations might only be available to viewer devices 160 that are connected to a particular private network or local intranet. Some semantic layer operations 147 may be user-defined, for example having been customized via the viewer device 160. Some semantic layer operations 147 may be mandatorily applied for certain users or certain viewer devices 160—for example, while a company director might be allowed to see day-to-day sales, a low-level employee or shareholder might only be allowed to see yearly totals.

Storing and performing the semantic layer operations 147 at the analysis server 110 helps speed up work by storing how certain tasks can be accomplished and automated. Storing and performing the semantic layer operations 110 at the analysis server 110 also helps make the ecosystem of FIG. 1 and FIG. 3 more secure by making it possible to keep certain data, such as day-to-day sales data, inaccessible from certain viewer devices 160 or to certain users of certain viewer devices 160 who should only be shown data after a particular semantic layer operation 147 is applied, such as a “yearly total” semantic layer or a “year-to-date (YTD)” semantic layer.

While the semantic layer operations 147 are illustrated as being stored at and performed by the analysis server 110, it should be understood that, in some cases, at least one semantic layer operation 147 may be stored at and/or performed at the viewer device 160, the host server(s) 165, or the data source(s) 120 via the analysis plugin 135.

The viewer device 160A of FIG. 3 illustrates series of notifications in which the intelligence 150 from the analysis server 110 is formatted into an intelligence stream 310. The intelligence stream 310 of FIG. 3 includes a mix of correlations, trends, predictions, and forecasts, but in some cases the intelligence stream 310 may be segregated to display only one of these types of intelligence 150 at a time. Furthermore, while the intelligence stream 310 of FIG. 3 is organized into a single column, it may instead be organized horizontally, or into a grid or table, or some combination thereof. The exemplary intelligence identified in the intelligence stream 310 of FIG. 3 includes a trend (“sales of soft drinks are highest on Tuesdays”), a prediction (“sales of pizza will be unusually high during Labor Day”), a correlation (“high tides correlate with low tomato sales”), and a forecast (“candy sales will slowly increase through Spring”).

The viewer device 160B of FIG. 3 illustrates an analytic visualization 330 in a portal page 320, in which the intelligence 150 from the analysis server 110 is illustrated in a more visual format. The analytic visualization 330 of FIG. 3 is illustrated as a graph, but may alternately be a chart or table. It should be understood that the analytic visualization 330 may be generated at the viewer device 160B based on the intelligence 150, or it may be generated at the analysis server 110 so that the intelligence 150 includes the already-generated analytic visualization 330, or some combination thereof. In some cases, at least part of the analytic visualization 330 may be generated at the host server 165 or at the data source(s) 120 (for example, via the analysis plugin 135).

The portal page 320 may include multiple analytic visualizations 330 rather than the one illustrated in FIG. 3. The portal page 320 may be an Internet website page or an intranet portal page viewed through a web browser. The portal page 320 may alternately be a “page” or interface view within a specific software application running on the viewer device 160B, or may be a document being viewed via a document viewer function/application running on the viewer device 160B. The portal page 320 may, in some cases, also include an interactive interface 335 making the analytic visualization 330 interactive allowing a user of the viewer device 160B to zoom in/out, filter the data viewed within the analytic visualization, or other operations.

In some cases, the intelligence 150 may immediately be presented in the form of the portal 320 with its analytic visualization 330. In other cases, interaction with a particular piece of intelligence in the intelligence stream 310 may open the portal 320 and include an analytic visualization 330 about that particular piece of intelligence, along with additional information that might be useful, such as the data source(s) 120 used to generate this particular piece of intelligence.

Regarding the viewer device 160B of FIG. 3, the analytic visualization 330 may be embedded into the portal page 320 via a container 325 through the use of HTML, XML, JSON, images, javascript, Ruby, Python, Java, Adobe Flash, Microsoft ActiveX, Microsoft Silverlight, C, C++, C sharp, Objective C, Swift, Go, PHP or some combination thereof. The container 325 may be embedded into the portal page 320 via markup language, scripting language, or some combination thereof. The markup language may include Hyper Text Markup Language (HTML), Extensible Markup Language (XML) JavaScript Object Notation (JSON), some variant thereof, or some combination thereof. The scripting language may include javascript, PHP Hypertext Preprocessor (PHP), Ruby, Python, Java, or another appropriate language. For example, the container 325 may be embedded into the portal 320 via an HTML iFrame or a PHP include.

While the analysis server(s) 110 illustrated in FIG. 1 and FIG. 3 and described in relation to FIG. 2 are discussed in the singular, it should be understood that multiple analysis servers 110 may be used to perform the operations discussed above in relation to the analysis server 110. In situations where multiple analysis severs 110 are used, such operations may be performed entirely by one of the analysis servers 110, may be performed piecemeal by multiple analysis servers 110, may be performed in parallel by multiple analysis servers 110, or some combination thereof. For example, different analysis models 145 may be stored by and/or run by different analysis servers 110. Likewise, while the host server(s) 165 illustrated in FIG. 1 and FIG. 3 are discussed in the singular, it should be understood that multiple host servers 165 may receive data from the analysis server(s) 110 and supply that data to the viewer device 160, for example piecemeal, in parallel, or some combination thereof.

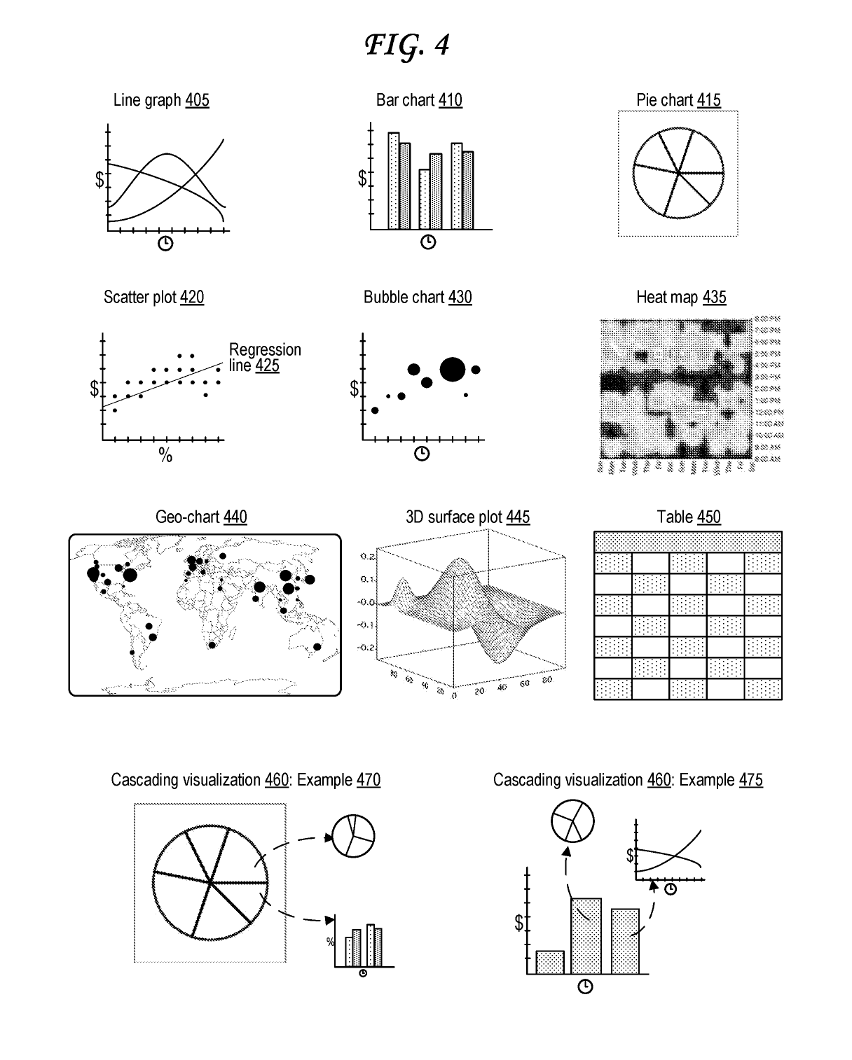

FIG. 4 illustrates various analytic visualization formats. As illustrated in FIG. 4, an analytic visualization 330 may include a line graph 405, a bar chart 410, a pie chart 415, a scatter plot 420, a bubble chart 430, a heat map 435, a map-based geo-chart 440, a three-dimensional surface plot 445, a table 450, or some combination thereof. While only the three-dimensional surface plot 445 of FIG. 4 is illustrated as conveying data using more than two dimensions, it should be understood that any of these other types of analytic visualizations may be generated in three or more dimensions. Furthermore, while the analytic visualization types illustrated in FIG. 4 are illustrate in black and white, it should be understood that some of these may convey an additional dimension of data by coloring certain points, lines, bars, “slices,” “bubbles,” values, or regions using different colors along a spectrum, or using different color intensities/saturations, or some combination thereof. For example, the heat map 435 may map data along a spectrum from red to blue even through it is illustrated in FIG. 4 mapping data along a spectrum from white to black. Additionally the three-dimensional surface plot 445 could in some cases convey a fourth dimension of data by being colored differently in different regions similarly to the heat map 435.

Some analytic visualizations 330 may be “cascading” analytic visualizations 460 in which selecting a portion of a “main” analytic visualization can result in display of a “secondary” analytic visualization describing the selected portion.

In one example 470 of a cascading visualization 460, a pie graph is displayed as the “main” analytic visualization. Selecting a first segment of the “main” pie graph in example 470 displays a “secondary” analytic visualization in the form of a “secondary” bar chart that illustrates further details about that selected first segment of the “main” pie graph of example 470. Selecting a second segment of the “main” pie graph in example 470 displays a “secondary” analytic visualization in the form of a “secondary” pie graph that illustrates further details about that selected second segment of the “main” pie graph of example 470.

In another example 475 of a cascading visualization 460, a bar chart is displayed as the “main” analytic visualization. Selecting a first segment of the “main” bar chart in example 475 displays a “secondary” analytic visualization in the form of a “secondary” pie chart that illustrates further details about that selected first segment of the “main” bar chart of example 475. Selecting a second segment of the “main” bar chart in example 475 displays a “secondary” analytic visualization in the form of a “secondary” line graph that illustrates further details about that selected second segment of the “main bar chart of example 475.

FIG. 5 illustrates an exemplary computing system 500 that may be used to implement an embodiment of the present invention. For example, any of the computer systems or computerized devices described herein may, in at least some cases, be a computing system 500. The computing system 500 of FIG. 5 includes one or more processors 510 and memory 510. Main memory 510 stores, in part, instructions and data for execution by processor 510. Main memory 510 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 510 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 510.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 500 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 500 may be part of a multi-computer system that uses multiple computer systems 500, each for one or more specific tasks or purposes. For example, the multi-computer system may include multiple computer systems 500 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 500 from different networks communicatively coupled together via the internet (also known as a “distributed” system).

While various diagrams provided and described above may show a particular order of operations performed by certain embodiments of the invention, it should be understood that such order is exemplary. Alternative embodiments may perform the operations in a different order, combine certain operations, overlap certain operations, or some combination thereof.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A system for providing intelligence, the system comprising:
a memory storing instructions and a plurality of correlation analysis models, wherein each correlation analysis model is previously-trained and distinct from a remainder of the plurality of correlation analysis models;
a communication transceiver receiving data from a data source; and
a processor coupled to the memory, wherein execution of the instructions by the processor causes the processor to:
identify a correlation within the data using a first correlation analysis model of the plurality of correlation analysis models,
adjust a confidence metric associated with the correlation based on a second correlation analysis model of the plurality of correlation analysis models, and
transmit correlation data to a viewer device, thereby triggering a notification identifying the correlation to be output at the viewer device.

2. The system of claim 1, wherein execution of the instructions by the processor further causes the processor to transmit the confidence metric to the viewer device.

3. The system of claim 1, wherein transmitting the correlation data to the viewer device is based on a determination that the confidence exceeds a predetermined confidence threshold.

4. The system of claim 1, further comprising, wherein the memory stores a semantic layer operation, the semantic layer operation including at least one of a mathematical operation or a filtering operation, and wherein execution of the instructions by the processor further modifies the data by performing the semantic layer operation on the data.

5. The system of claim 1, wherein execution of the instructions by the processor further causes the processor to adjust at least a subset of the plurality of correlation analysis models based on at least a subset of the data received from the data source.

6. The system of claim 1, wherein execution of the instructions by the processor further causes the processor to:
identify that the correlation remains true in the data received from the data source by the communication transceiver, and
adjust a model confidence level associated with the first correlation model based on the identification that the correlation remains true in the data received from the data source by the communication transceiver.

7. The system of claim 1, wherein execution of the instructions by the processor further causes the processor to:
identify that the correlation does not remain true in the data received from the data source by the communication transceiver, and
adjust a model confidence level associated with the first correlation model based on the identification that the correlation does not remain true in the data received from the data source by the communication transceiver.

8. The system of claim 1, wherein execution of the instructions by the processor further causes the processor to identify a trend based on the identified correlation, wherein the notification triggered by the correlation data further identifies the trend.

9. The system of claim 1, wherein execution of the instructions by the processor further causes the processor to identify a prediction based on the identified correlation, wherein the notification triggered by the correlation data further identifies the prediction.

10. The system of claim 1, wherein execution of the instructions by the processor further causes the processor to format the correlation data so that the notification includes an analytic visualization, the analytic visualization including one of a chart, a graph, or a table.

11. A method for providing intelligence, the method comprising:
storing a plurality of correlation analysis models in a memory, wherein each correlation analysis model is previously-trained and distinct from a remainder of the plurality of correlation analysis models;
receiving data from a data source;
identifying a correlation within the data using a first correlation analysis model of the plurality of correlation analysis models;
adjusting a confidence metric associated with the correlation based on a second correlation analysis model of the plurality of correlation analysis models; and
transmitting correlation data to a viewer device, thereby triggering a notification identifying the correlation to be output at the viewer device.

12. The method of claim 11, further comprising transmitting the confidence metric to the viewer device.

13. The method of claim 11, wherein transmitting the correlation data to the viewer device is based on a determination that the confidence exceeds a predetermined confidence threshold.

14. The method of claim 11, further comprising:
storing a semantic layer operation, the semantic layer operation including at least one of a mathematical operation or a filtering operation; and
modifying the data by performing the semantic layer operation on the data.

15. The method of claim 11, further comprising adjusting at least a subset of the plurality of correlation analysis models based on at least a subset of the data received from the data source.

16. The method of claim 11, further comprising:
identifying that the correlation remains true in the data received from the data source; and
adjusting a model confidence level associated with the first correlation analysis model based on the identification that the correlation remains true in the data received from the data source by the communication transceiver.

17. The method of claim 11, further comprising:
identifying that the correlation does not remain true in the data received from the data source; and
adjusting a model confidence level associated with the first correlation analysis model based on the identification that the correlation does not remain true in the data received from the data source by the communication transceiver.

18. The method of claim 11, further comprising identifying a trend based on the identified correlation, wherein the notification triggered by the correlation data further identifies the trend.

19. The method of claim 11, further comprising identifying a prediction based on the identified correlation, wherein the notification triggered by the correlation data further identifies the prediction.

20. The method of claim 11, further comprising formatting the correlation data so that the notification includes an analytic visualization, the analytic visualization including one of a chart, a graph, or a table.

21. A non-transitory computer-readable storage medium, having embodied thereon a program executable by a processor to perform a method for providing intelligence, the method comprising:
storing a plurality of correlation analysis models in a memory, wherein each correlation analysis model is previously-trained and distinct from a remainder of the plurality of correlation analysis models;
receiving data from a data source;
identifying a correlation within the data using a first correlation analysis model of the plurality of correlation analysis models;
adjusting a confidence metric associated with the correlation based on a second correlation analysis model of the plurality of correlation analysis models other than the first correlation analysis model; and
transmitting correlation data to a viewer device, thereby triggering a notification identifying the correlation to be output at the viewer device.
